(19) United States
(12) Patent Application Publication
(10) Pub. No.: US 2006/0012975 A1
(43) Pub. Date: Jan. 19, 2006

(54) Sport goggle with increased visibility

(76) Inventors: Josef Huttner, Regensburg (DE); Gunter Kirchberger, Sinzing (DE)

Correspondence Address: FISH & RICHARDSON PC, P.O. BOX 1022, MINNEAPOLIS, MN, 55440-1022, US

(21) Appl. No.: 11/146,919

(22) Filed: Jun. 7, 2005

(30) Foreign Application Priority Data
Jul. 16, 2004 (DE) 10 2004 034 644.5
Nov. 3, 2004 (DE) 10 2004 053 128.5

(51) Int. Cl. F21V 21/084

(52) U.S. Cl. 362/105; 362/276

(57) ABSTRACT

The invention concerns a sport goggle comprising at least one active light source for increasing the external visibility of the user.

### CROSS REFERENCE TO RELATED APPLICATIONS

Pursuant to 35 U.S.C. § 119, this application claims the benefit of prior German Patent Application No. 10 2004 034 644.5, filed Jul. 16, 2004, and German Patent Application No. 10 2004 053 128.5, filed Nov. 3, 2004. The contents of the prior applications are incorporated herein by reference in its entirety.

### FIELD OF THE INVENTION

The invention concerns a sport goggle with increased visibility.

### BACKGROUND OF THE INVENTION

When visibility is limited, for example due to fog or twilight, the sportspeople is often at an increased risk of accidents since it is difficult for him to be seen by other traffic.

Brightly colored clothing or reflectors, for example, can be of some service in this regard. However, these means presuppose a certain amount of environmental brightness. A conventional headlamp can also be used, but is often comparatively heavy and cumbersome.

### SUMMARY OF THE INVENTION

According to one aspect of the present invention, to increase external visibility, i.e., visibility to other traffic, an active light source is integrated into a sport goggle. The sport goggle provides a device for sportspeople that provides increased visibility. Integrating the active light source into the sport goggle provides the advantage of not having to take along an additional item, as is the case, for example, when a headlamp is used. In contrast to integrating the light source into other gear, such as, for example, articles of clothing (e.g. caps), a goggle affords the advantage of normally being subjected to very little mechanical stress.

The frame of the sport goggle is preferably made from a particularly robust material. In addition, a sport goggle is preferably designed to allow its user the broadest possible field of vision. The lenses of the sport goggle can be tinted to provide better contrast or to keep the user from being blinded by glare. In addition, the lenses of the goggle can comprise synthetic material as well as glass, to lower the weight of the goggle and reduce the risk of injury in the event of a fall. It is also conceivable for the lenses of a sport goggle to be ground to compensate for defective eyesight on the part of the user. In addition to temples, the sport goggle can additionally or alternatively include a strap to secure the goggle on the head.

Particularly preferably, it is provided to use the sport goggle for cycling or skiing. In sports of these kinds it is particularly advantageous, in order to prevent accidents, to be seen by other people even when visibility is limited.

In an advantageous improvement of the invention, the active light source emits white or red light. A white active light source provides the advantage of usually being especially bright, and thus being readily visible even from great distances. A red light source can, for example, be positioned on the goggle so that it shines substantially opposite the direction of travel of the sportsperson and thus advantageously serves as a sort of “taillight.”

Both static illumination and flashing can be provided as operating modes for the light source. Static illumination is usually preferable if the light source is positioned so that light from it falls within the user's field of vision. Causing the active light source to flash provides the advantage of exerting an additional signal effect on external observers. Such an additional signal effect can be desirable, for example, when a red light source is used, since red light usually looks darker than other colors to an observer.

In an advantageous improvement of the invention, the active light source is activated automatically by an ambient light detector. Alternatively, the active light source can be switched on and off by the user by means of a switch. Automatic activation of the light source by an ambient light sensor provides the advantage that the light source will not fail to be turned on because the user has forgotten to do so. In addition, the user need not interrupt the activity he is engaged in to activate the light.

The active light source used is preferably an LED (light-emitting diode). An LED is a component that includes a semiconductor chip. This semiconductor chip comprises an active layer sequence that is suitable for generating electromagnetic radiation when operating. LEDs are advantageously distinguished by their very low weight and spatial requirements, low power consumption, and long life.

The LEDs used are preferably bright-light LEDs, for example based on InGaAlP or InGaAlN. Both external visibility and visibility for the user can advantageously be increased in this fashion.

“Based on InGaAlN” means in the present context that the active layer sequence or at least a portion thereof comprises a compound semiconductor material of the following formula: AlₙGaₘIn₁₋ₙ₋ₘN, where 0≦n≦1, 0≦m≦1 and n+m≦1. The composition of this material need not be mathematically exactly that of the above formula. Rather, it can comprise one or more dopants and additional constituents that do not substantially alter the characteristic physical properties of an AlₙGaₘIn₁₋ₙ₋ₘN material. For the sake of simplicity, however, the above formula includes only the essential constituents of the crystal lattice (Al, Ga, In, N), even though these can be partially replaced by minimal quantities of additional substances.

In addition, “based on InGaAlP” in the present context means that the active layer sequence or at least a portion thereof comprises a compound semiconductor material of the following formula: AlₙGaₘIn₁₋ₙ₋ₘP, where 0≦n≦1, 0≦m≦1 and n+m≦1. The composition of this material need not be mathematically exactly that of the above formula. Rather, it can comprise one or more dopants and additional constituents that do not substantially alter the characteristic physical properties of an AlₙGaₘIn₁₋ₙ₋ₘP material. For the sake of simplicity, however, the above formula includes only the essential constituents of the crystal lattice (Al, Ga, In, P), even though these can be partially replaced by minimal quantities of additional substances.

Moreover, the active light source can also serve to improve the vision of the sports participant himself. To this end, the active light source is preferably positioned centrally in the region of the lenses, and a particularly bright active light source is used, such as an LED, for example.

Additional features, advantages and expediencies of the invention will emerge from the following exemplary embodiments, described in conjunction with FIGS. 1a to 1c and 2.

### BRIEF DESCRIPTION OF THE DRAWINGS

FIGS. 1a to 1c are schematic perspective views of different exemplary embodiments of the sport goggle, and

FIG. 2 is an additional schematic perspective view of a further exemplary embodiment of the sport goggle.

### DETAILED DESCRIPTION OF THE INVENTION

In the exemplary embodiments and the figures, like or like-acting elements are provided with the same respective reference numerals. The illustrated elements of the figures should not be considered true to scale. They may instead be depicted as over-large in some cases for better comprehension.

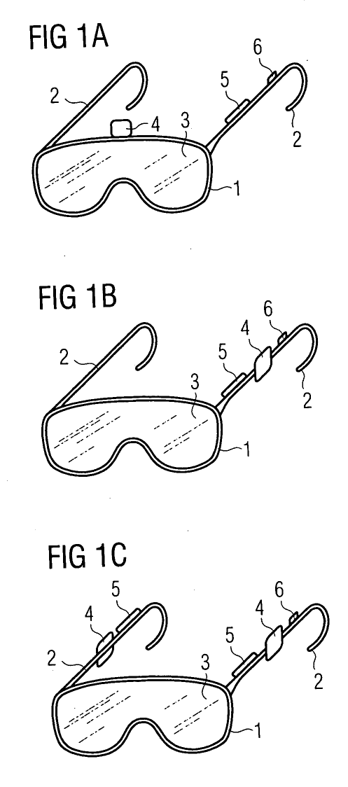

In the exemplary embodiments of FIGS. 1a to 1c, the goggle comprises a frame 1 with temples 2 and lenses 3.

In the exemplary embodiment of FIG. 1a, an LED 4, as the active light source, is fastened to the frame 1 of the goggle centrally above the lenses 3. The power supply 5 to the LED is effected via a replaceable or rechargeable battery, which is also disposed on frame 1. The LED 4 can be turned on or off via a switch 6. The switch 6 also makes it possible to select different operating modes of the LED 4, such as, for example, flashing or static illumination.

In contrast to the exemplary embodiment of FIG. 1a, the LED 4 in the exemplary embodiment according to FIG. 1b is positioned laterally on the temple 2 of the sport goggle.

In the exemplary embodiment of FIG. 1c, in contrast to the exemplary embodiments of FIGS. 1a and 1b, two LEDs 4 are each fastened laterally to a respective temple 2 of the sport goggle.

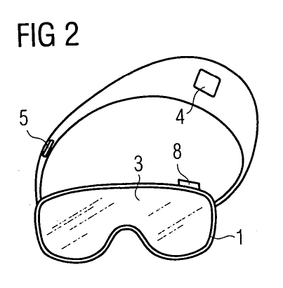

In the exemplary embodiment of FIG. 2, the sport goggle comprises, instead of the temples 2, a strap 7 by which the goggle is secured on the head. LED 4 is fastened in the center of strap 7, so that it is located on the back of the user's head and radiates backward when the goggle is in use. Positioned above lenses 3 laterally on frame 1 is an environmental sensor 8 that automatically switches LED 4 on when the ambient brightness falls below a given level.

The scope of the invention is not limited by the description of the invention with reference to the exemplary embodiments. Rather, the invention encompasses any novel feature and any combination of features, particularly including any combination of the features recited in the claims, even if that combination is not mentioned explicitly in the claims.

What is claimed is:

1. A sport goggle comprising at least one active light source for increasing the external visibility of the user.

2. The sport goggle as described in claim 1, which is a cycling goggle or a ski goggle.

3. The sport goggle as described in claim 1, wherein said active light source emits white or red light.

4. The sport goggle as described in claim 1, whose active light source provides at least the operating modes illuminate and flash.

5. The sport goggle as described in claim 1, comprising an ambient light sensor that turns said active light source on and off.

6. The sport goggle as described in claim 1, wherein said active light source is an LED.

7. The sport goggle as described in claim 2, wherein said active light source emits white or red light.

8. The sport goggle as described in claim 2, whose active light source provides at least the operating modes illuminate and flash.

9. The sport goggle as described in claim 3, whose active light source provides at least the operating modes illuminate and flash.

10. The sport goggle as described in claim 2, comprising an ambient light sensor that turns said active light source on and off.

11. The sport goggle as described in claim 3, comprising an ambient light sensor that turns said active light source on and off.

12. The sport goggle as described in claim 4, comprising an ambient light sensor that turns said active light source on and off.
